(19) United States
(12) Patent Application Publication
(10) Pub. No.: US 2025/0276631 A1
(43) Pub. Date: Sep. 4, 2025

(54) A FASTENING ASSEMBLY FOR USE IN A CARRIER SUCH AS A PICK-UP/TRUCK BED AND A METHOD FOR DETACHABLY FASTENING AN OBJECT TO A CARRIER SUCH AS A PICK-UP/TRUCK BED

(71) Applicant: Peak Polar Holding AS, STOKKE (NO)

(72) Inventor: Øystein Gunneng, Tolvsrød (NO)

(21) Appl. No.: 18/860,570

(22) PCT Filed: Apr. 28, 2023
(86) PCT No.: PCT/NO2023/050098

§ 371 Date: Oct. 25, 2024

(30) Foreign Application Priority Data
Apr. 29, 2022 (NO) 20220494

(51) Int. Cl. B60P 7/08; B60R 9/06

(52) U.S. Cl. CPC B60P 7/0815; B60R 9/065

(57) ABSTRACT

The disclosure relates to a fastening assembly for use in a carrier such as a pick-up/truck bed comprising: one or more casing profile lists attached to an object to be detachably fastened, the casing profile list is arranged at a side of the object facing a casing profile locking assembly arranged on the carrier, the casing profile locking assembly comprising: a horizontal bottom side profile list, one or more of a first fastener for holding the horizontal bottom side profile list, wherein the horizontal bottom side profile list fastened to the carrier, and arranged to receive the casing profile list, and a vertical bottom side profile list arranged to interact with the horizontal bottom side profile list for fastening the casing profile list in a locking grip. The disclosure further relates to a method for fastening an object to a carrier such as a pick-up/truck bed the method.

### TECHNICAL FIELD

The present disclosure relates to a fastening assembly for use in a carrier such as a pick-up/truck bed and a method for fastening an object to a carrier such as a pick-up/truck bed the method. More specifically, the disclosure relates to a fastening assembly for use in a carrier such as a pick-up/truck bed and a method for fastening an object to a carrier such as a pick-up/truck bed the method as defined in the introductory parts of the independent claims.

### BACKGROUND ART

A problem with the solutions of the prior art is that custom built carrier equipment needs to be built to accommodate to regulations when fastening all covering boxes, crates, hoods or the like onto a pick-up/truck bed. Sometimes it is sufficient to customize these to adapt to cargo lashing belt connectors attached to lashing points/eyes suitable for the purpose. When the requirements to attach objects that must be attached above the side panels for any reason, there are huge challenges to comply with safety regulations. In order to attach the objects safely this has previously been solved by customizing the carrier at huge costs and individual adaptations to each version of carrier used. There is thus a need for improved fastening assembly for use in a carrier, such as a pick-up/truck, for attaching an object to the carrier.

### SUMMARY

It is an object of the present disclosure to mitigate, alleviate or eliminate one or more of the above-identified deficiencies and disadvantages in the prior art and solve at least the above mentioned problem. According to a first aspect there is provided a fastening assembly for use in a carrier such as a pick-up/truck bed comprising: one or more casing profile lists for being attached to an object to be detachably fastened, the casing profile list is arranged at a side of the object facing a casing profile locking assembly arranged on the carrier, the casing profile locking assembly comprising: a horizontal bottom side profile list, one or more of a first fastening means for holding the horizontal bottom side profile list, wherein the horizontal bottom side profile list being fastened to the carrier, and being arranged to receive the casing profile list, and a vertical bottom side profile list for being arranged to interact with the horizontal bottom side profile list for fastening the casing profile list in a locking grip.

The advantage is that it is now facilitated a common (“one size” fits all type) method, that may be non-intrusive on the carrier bodywork/framework, for providing a quick, safe, flexible fastening of objects to a carrier. Typically a carrier is pick-up/truck, and the object may be a large crate/box to be arranged on the pick-up/truck bed above the side panels. As long as the object is provided with casing profile list, or having casing profile list arranged to it, the object itself provides a portion of the fastening assembly.

According to some embodiments, the casing profile list may comprise a first connecting element, and the horizontal bottom side profile list comprise a first corresponding connecting element for interacting in a guiding operation with the first connecting element.

Thus it is advantageously provided an easy way to guide the loading of the object in a quick and safe manner.

According to some embodiments, the casing profile list may further comprise a second connecting element, and the vertical bottom side profile list comprise a second corresponding connecting element for interacting in a locking grip with the second connecting element.

The advantage of the latter element is that the “locking” of the fastening assembly is done post arranging the object on the carrier at convenient and easy locations along the side of the carrier.

According to some embodiments, the horizontal bottom side profile list and the vertical bottom side profile list is provided in a combined bottom side profile list.

For non-easy to reach sides after object is arranged on the carrier, for example the front side of a box reaching all the way to the front panel which often is located next to a drivers cabin back wall, it is provided a combined profile list preventing forward gliding of the object.

According to some embodiments, the fastening assembly may further comprising: two or more locking member assemblies comprising a lock member connecting element corresponding to the first corresponding connecting element of the horizontal bottom side profile list, and the horizontal bottom side profile list comprising two or more grooves for receiving the locking members, and the locking member assembly having: at least one locking member holding means for holding the locking members in the horizontal bottom side profile list groove, and at least one locking member receiving element, the horizontal bottom side profile list, the locking member receiving element, and the vertical bottom side profile list having corresponding conduits for receiving a connecting bolt for fastening the vertical bottom side profile list to the horizontal bottom side profile list.

Thus, a locking element having a resilient lock-in/lock-out performance facilitating easy attachment and release is provided.

According to some embodiments, the first fastening means may comprising: a vertical downward pulling fastening element for holding the horizontal bottom side profile list in the vertical direction to the carrier, and a horizontal working fastening element for aligning and holding the horizontal bottom side profile list in the horizontal direction relative the carrier.

Thus, a separate assembly is arranged to the carrier pre-arranging the object in a secure manner.

According to some embodiments, the vertical downward pulling fastening element may be comprised of: a vertical holding element being arranged in a second fastening means, and a first receiving groove being arranged longitudinally in the underside of the horizontal bottom side profile list, the first receiving groove having a form to receive and hold the vertical holding element.

According to some embodiments, the horizontal working fastening element may be comprised of: a horizontal holding element being arranged in a second fastening means, and a second receiving groove being arranged longitudinally in a first side of the horizontal bottom side profile list, the second receiving groove having a form to receive and hold the horizontal holding element.

Thus, a quick and reliable way to arrange the horizontal holding element is provided pre-arranging the object to the carrier.

According to some embodiments, the horizontal bottom side profile list may further comprise a first weight transfer element, and the vertical bottom side profile list further comprising a second weight transfer element, wherein the first weight transfer/alignment element and the second weight transfer/alignment element cooperates to transfer and hold the weight of the object attached to the carrier.

According to some embodiments, the second fastening means comprise: the vertical holding element, the horizontal holding element, and a carrier fastening element for fastening the second fastening means to the carrier.

Combining a fastening module with the object fastening assemblies provides a further flexibility to the assemblies, and easy fitting in a non-intrusive manner may be provided.

According to some embodiments, the carrier may be a pick-up truck/lorry bed having the carrier fastening elements for fastening the second fastening means to the carrier arranged on any of the top side of side and front bed panel, the topside of the panel having an inward facing collar to provide an upside down oriented fold, and the carrier fastening elements the fastening comprises: a lower vertical portion of an inner element for being arranged on the inside of the upside down oriented fold, a lower vertical portion of an outer element or being arranged on the outside of the upside down oriented fold, and a fastening device arranged to pinch and hold the upside down oriented fold between the lower vertical portion of an inner element and the lower vertical portion of an outer element, the inner element further comprising: an upper horizontal portion for holding the vertical holding element, and an upper extension portion for holding the horizontal holding element, and the outer element further comprising: an upper horizontal portion for holding a stabilizing bolt.

This embodiment will fit to many Pick-up trucks on the market, but other mechanism for fastening the second fastening elements may be provided.

According to some embodiments, the second fastening means may further comprise: a third fastening means for further securing the second fastening means to the carrier.

This embodiment will fit to many Pick-up trucks on the market, but other mechanism for fastening the second fastening elements may be provided.

According to some embodiments, the third fastening means comprise a strap fastening element providing fastening of a securing connector/strap to the carrier.

It may be advantageous to further secure any objects with easy accessible strap fastening elements.

According to some embodiments, the carrier may be a pick-up truck/lorry bed having a horizontal bottom side profile list arranged on the top side of side and front bed panel, and the object is a container having mounted: on its underside two longitudinal parallel running casing profile list for being cooperating with the horizontal bottom side profile list arranged on the side panel, and on the forward facing underside a further profile list for being cooperating with the horizontal bottom side profile list arranged on the front panel, and the second fastening means are arranged on the top side of side bed panel of the pick-up truck/lorry bed.

According to some embodiments the first connecting element, and the first corresponding connecting element of the horizontal bottom side profile list is composed of a protrusion interacting with a groove.

According to some embodiments the second connecting element, and the second corresponding connecting element of the vertical bottom side profile list is composed of a protrusion interacting with a groove.

These protrusions and grooves correspond in form, and may be interchanged. In some embodiments the first corresponding connecting element allow for receiving the object in a straight downward movement loading operation.

According to some embodiments, the fastening assembly may further comprise a roof casing profile list for being attached to an object to be detachably fastened, the roof casing profile list is arranged at a different side of the object facing the casing profile locking assembly arranged on the carrier, a horizontal top side profile list, and a vertical top side profile list for being arranged to interact with the horizontal top side profile list for fastening the roof casing profile list in a locking grip.

According to some embodiments, the fastening comprises: a fourth fastening means for securing a further object to the roof casing profile list.

The roof casing profile list and its associated parts may be arranged to an object independently of the fastening assembly.

By modifying the fastening assembly slightly it may be possible to fasten additional rooftop objects to the object via this roof casing profile list.

According to some embodiments, the fastening assembly may comprise: a blind casing profile list for being attached to an object to be detachably fastened, the blind casing profile list is arranged at the lower end of the rear side of the object facing the upper end of a tailgate, and a tail gasket having an inner form mirroring and adapted to being arranged to interact with the first and second connecting elements of the blind casing profile list in a locking manner, and the tail gasket may further comprise a downward pointing flange portion being arranged to close a gap between the tail gasket and the top of the tailgate.

For any side not being locked by the fastening assembly, it is advantageously provided a seal for preventing dirt to enter into the space below the object.

According to a second aspect there is provided a method for fastening an object to a carrier such as a pick-up/truck bed the method comprising the steps: arranging one or more casing profile list according to the first aspect to an object to be arranged on a carrier, mounting a two or more carrier fastening element to the carrier, mounting one or more horizontal bottom side profile lists to the two or more carrier fastening element, mounting the casing profile list arranged on the object into the corresponding horizontal bottom side profile lists, mounting one or more vertical bottom side profile list to the horizontal bottom side profile lists, and thereby fastening the object in a tight grip.

According to some embodiments, the method comprises the further steps: arranging a blind casing profile list at the lower end of the rear side of the object facing the upper end of a tailgate of the carrier.

According to some embodiments, the method comprises the further steps; fastening one or more roof casing profile list to the upper portion of an object at the opposite side of the object facing the casing profile locking assembly arranged on the carrier, and arranging a fourth fastening means for securing a further object to the roof casing profile list.

Effects and features of the second aspect are to a large extent analogous to those described above in connection with the first aspect. Embodiments mentioned in relation to the first aspect are largely compatible with the second aspect.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings do not exclude other elements or steps.

The term “horizontal” and “vertical” is to be interpreted as the element's relative arrangement to each other, and wording is selected to fit the elements posture in the figures, but other embodiments are encompassed even if they may arrange the elements in other directions.

The term “carrier” is used to describe the entity that the fastening means of the present disclosure is used to arrange an object to, and shall be interpreted in widest meaning to at least comprise: pick-up trucks, lorries, barges, cars, boats, planes, drones or any type of carrier of fixed installation.

The terms “arranged on” and “onto” is to be understood not being connected to up or down or any direction. The phrases denotes how the parts relates to each other independent on word coordinates.

The terms “profile list” is to be understood as any type of profile list being manufactured from any type of material. Typically some profile lists are made from extruded aluminum, but other materials may advantageously be used adapted to the environment it is to be used and for the task to be solved.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 shows a pick-up truck having an object/box arranged on the bed

FIG. 2 shows a cross section of the fastening means according to present disclosure

FIG. 3 shows an embodiment of the locking member assembly and parts

FIG. 4 shows an embodiment of the horizontal bottom side profile list and the groove for receiving the locking member

FIG. 5 shows an embodiment of the horizontal bottom side profile list arranged for receiving an object having a square/rectangular bottom form.

FIG. 6 shows an embodiment of the horizontal bottom side profile list and the vertical bottom side profile list seen from various angles

FIG. 7 shows an embodiment of a casing profile list seen from various angles

FIG. 8 shows an embodiment of shows a section of an embodiment of casing profile list with the horizontal bottom side profile list and the vertical bottom side profile list arranged to grip the casing profile list seen from various angles

FIG. 9 shows an embodiment of the fastening assembly in a disassembled manner, and with blown up sections

FIG. 10 shows an embodiment of the second fastening means to be arranged on the carrier

FIG. 11 shows an embodiment of the gasket for being arranged in the horizontal bottom side profile list

FIG. 12 shows an embodiment of a corner fastening profile

FIG. 13 shows an embodiment of a first step of arranging the fastening assembly on a pick-up truck

FIG. 14 shows an embodiment of a second step of arranging the fastening assembly on a pick-up truck

FIG. 15 shows an embodiment of a third step of arranging the fastening assembly on a pick-up truck

FIG. 16 shows an embodiment of a fourth step of arranging the fastening assembly on a pick-up truck

FIG. 17 shows an embodiment of a final step of arranging the fastening assembly on a pick-up truck

FIG. 18 shows an embodiment of shows a section of an embodiment of the horizontal top side profile list and the vertical top side profile list arranged to grip the casing profile list seen from various angles

FIG. 19 shows an embodiment of shows a section of an embodiment of the horizontal top side profile list and the vertical top side profile list gripping the casing profile list seen from various angles

FIG. 20 shows an embodiment of the elements of a fourth fastening means

FIG. 21 show how the fourth fastening means is arranged to provide fastening means for securing further objects to the roof casing profile list.

FIG. 22 shows an embodiment of a tail gasket

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

The figures exemplify embodiments of present disclosure arranging a box object on a pick-up truck, but the nature of the disclosure is such that it may be arranged to fasten any object to any carrier providing a suitable support for the fastening assembly as described. Thus, the reader should understand that the fastening assembly may be used on lorries, barges, cars, boats, planes, drones or any type of carrier of fixed installation.

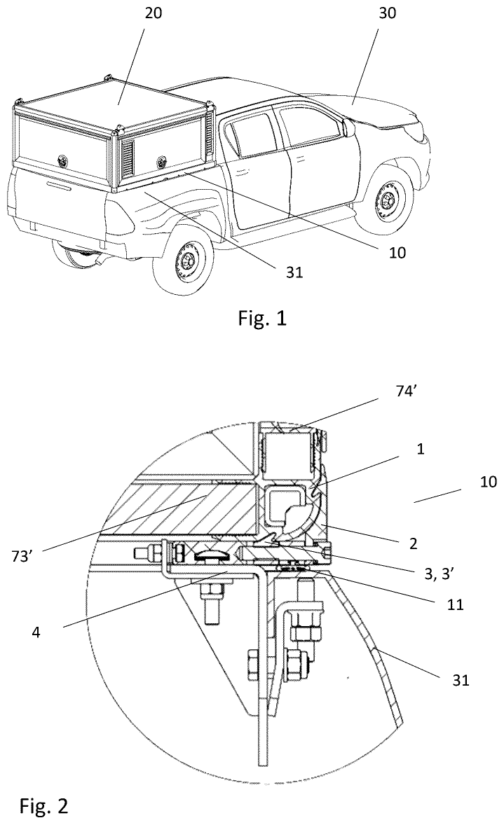

FIG. 1 shows a box 20 arranged on a pick-up 30 using the fastening assembly 10 of present disclosure. A cross section showing the details of the fastening assembly 10 is shown in FIG. 2.

The first aspect of this disclosure shows a fastening assembly for use in a carrier 30 such as a pick-up/truck bed comprising: one or more casing profile list 1 for being attached to an object 20 to be detachably fastened, the casing profile list 1 is arranged at the side of the object 20 facing a casing profile locking assembly arranged on the carrier 30, the casing profile locking assembly comprising: a horizontal bottom side profile list 3,3′,35′, one or more of a first fastening means for holding the horizontal bottom side profile list 3,3′,35′, wherein the horizontal bottom side profile list 3,3′,35′ being fastened to the carrier 30, and being arranged to receive the casing profile list 1, and a vertical bottom side profile list 2, 35″ for being arranged to interact with the horizontal bottom side profile list 3,3′,35′ for fastening the casing profile list 1 in a locking grip.

As shown in the figures the casing profile list 1 is arranged on the lower side corner of the box 20 to be detachably fastened to the top end of the pick-up truck side panels 31. In some embodiments the casing profile list 1 is designed to be an integral part of the box itself, and then having optional receiving openings 73, 74 for holding an end portion of a box floor 73′ or box side wall 74′, as illustrated in FIGS. 2 and 7. The casing profile list 1 does however not necessarily have these receiving openings 73, 74, as it is the outside profile form 100 that is providing for the locking grip interacting with the horizontal bottom side profile list 3,3′,35′ being fastened to the carrier 30, and the vertical bottom side profile list 2, 35″. In the figures this outside form of the casing profile list 1 has an arced convex corner form and further providing an outward facing recess 71, 72 at the end of the arc at both sides to receive corresponding protrusions 24, 34, 34′ of the horizontal bottom side profile list 3,3′,35′ being fastened to the carrier 30, and the vertical bottom side profile list 2, 35″. The form of the recesses 71, 72 are shown in the figures as examples only, and it should be understood that other forms may be provided within the concept of the present disclosure.

In one embodiment the casing profile list 1 thus comprise a first connecting element 71, and the horizontal bottom side profile list 3,3′,35′ comprise a first corresponding connecting element 34, 34′ for interacting in a guiding operation with the first connecting element 71.

Since the horizontal bottom side profile list 3,3′,35′ is prearranged on the carrier 30, at for example onto the top railing of the two side panels and the front panel of the pick-up bed, the first corresponding connecting element 34 of these horizontal bottom side profile list 3,3′,35′ are facing towards the object/box to be arranged on the pick-up. These first corresponding connecting element 34, must be arranged to enable the box 20 being framed with corresponding casing profile lists 1 to enter around the span w, indicated in FIG. 5, between the outward facing first connecting elements 34. Thus the width between the inside of the first connecting elements 71 of the casing profile lists arranged on the sides of the box 20 must be wider than w. It is also within the concept of present disclosure to use these outward facing connecting elements 34 as guiding elements for arranging the object to be detachably fastened correctly onto the horizontal bottom side profile lists 3,3′,35′.

In the case the fastening assembly only comprises one single horizontal bottom side profile list 3,3′,35′, the span element becomes irrelevant. In this case the first connecting elements 71 of the casing profile list arranged on the object 20 is arranged adjacent and parallel to the outward facing connecting elements 34, outward in the sense of the side to witch the vertical bottom side profile list 2, 35″ is to be arranged.

The casing profile list 1 further comprises a second connecting element 72, and the vertical bottom side profile list 2, 35″ comprise a second corresponding connecting element 24 for interacting in a locking grip with the second connecting element 72. When the object 20 is arranged on the horizontal bottom side profile lists 3,3′,35′, the vertical bottom side profile list 2, 35″ may be arranged such that the second corresponding connecting element 24 interact with the second connecting element 72. Thus, the first corresponding connecting element 34 in combination with the second corresponding connecting element 24 interacts in a locking operation on the first connecting elements 71 and the second connecting element 72 thus holds the object 20 in a locking grip, as illustrated in FIG. 8.

In a version adapted to be arranged in the front pointing side of the carrier the horizontal bottom side profile list 35′ and the vertical bottom side profile list 35″ may be provided in a combined bottom side profile list 35.

The fastening assembly may further comprise two or more locking member assemblies 3′ the locking member comprises a lock member connecting element 34′ corresponding to the first corresponding connecting element 34 of the horizontal bottom side profile list 3, and the horizontal bottom side profile list 3 comprising two or more grooves 3″ for receiving the locking members 3′, and the locking member assembly 3′ having: at least one locking member holding means 131, 131′, 131″, 131′″ for holding the locking members 3′ in the horizontal bottom side profile list groove 3″, and at least one further locking member receiving element 132, the horizontal bottom side profile list 3, the further locking member receiving element 132, and the vertical bottom side profile list 2 having corresponding further conduits 132, 132′, 132′″ for receiving a connecting bolt 132″ for fastening the vertical bottom side profile list 2, 35″ to the horizontal bottom side profile list 3,3′,35′.

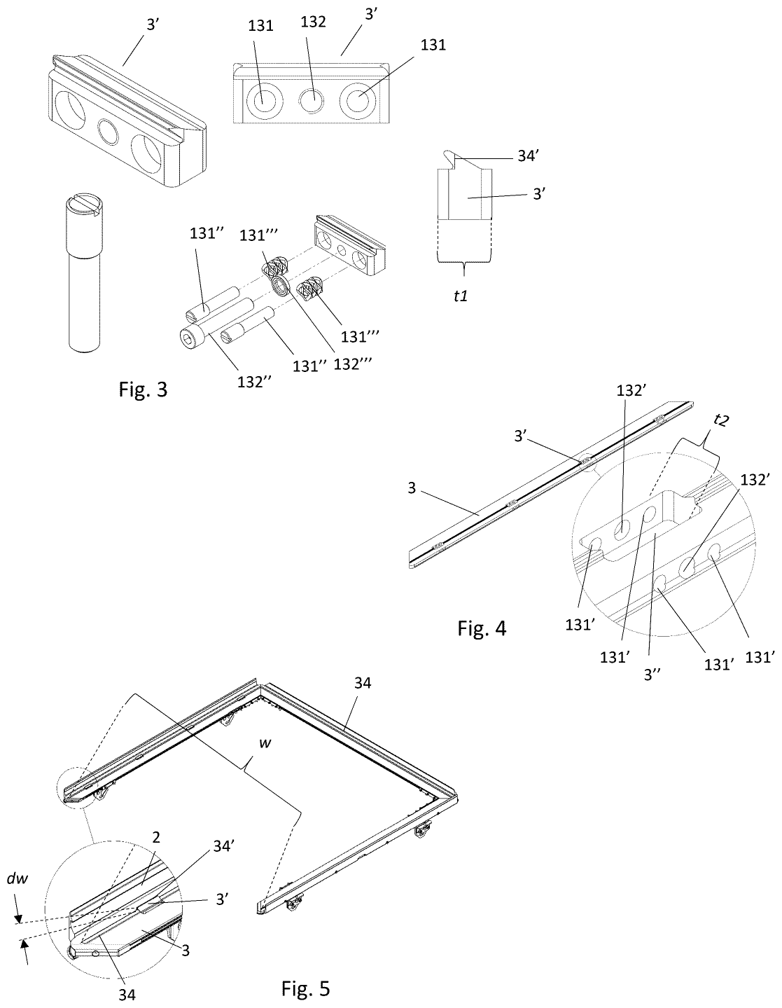

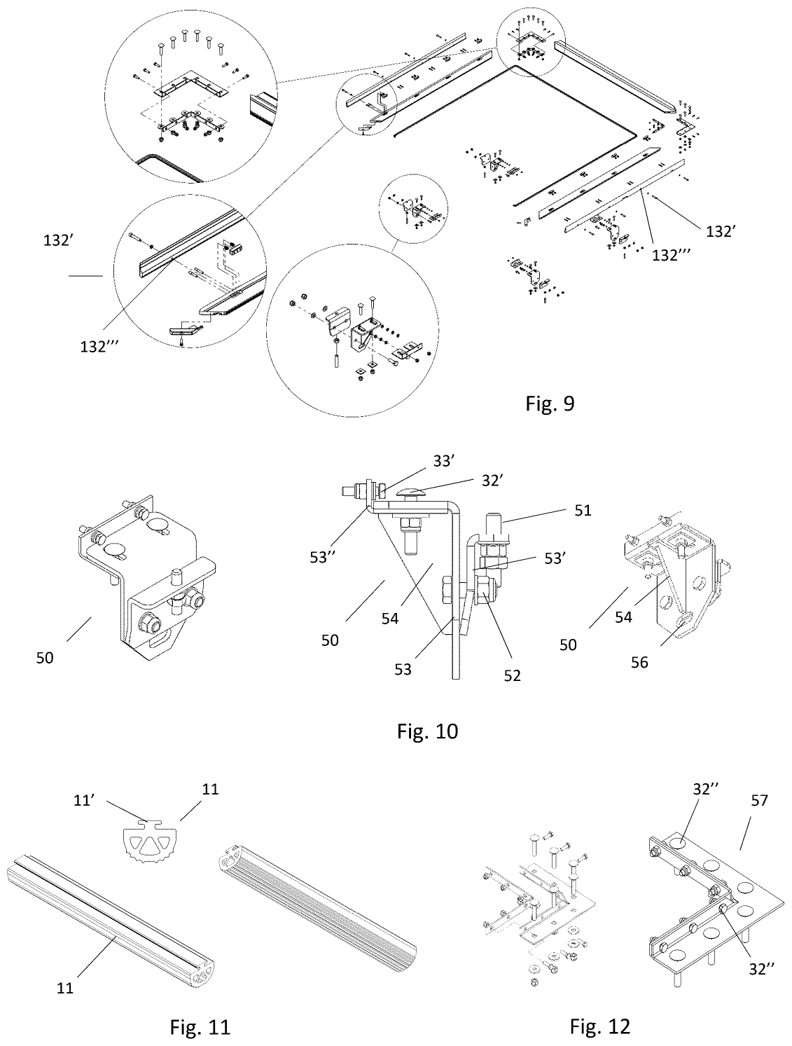

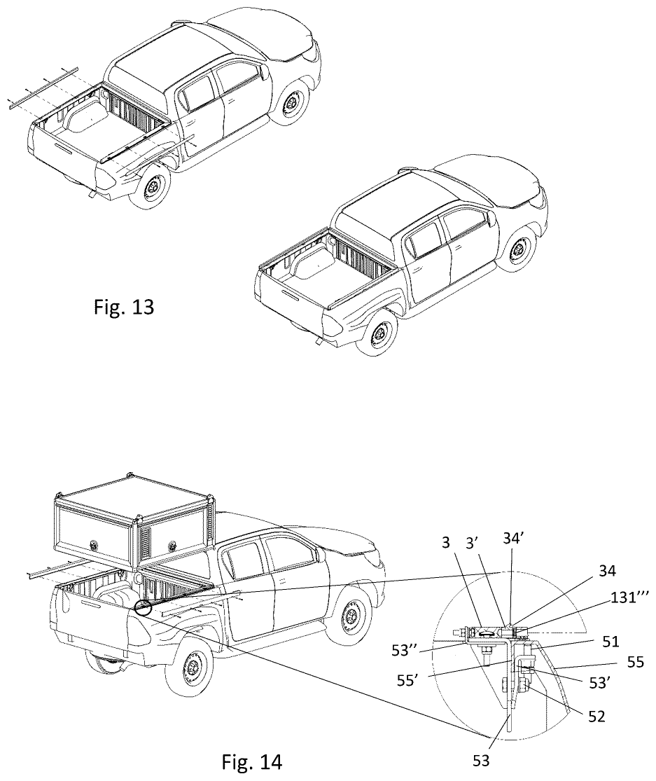

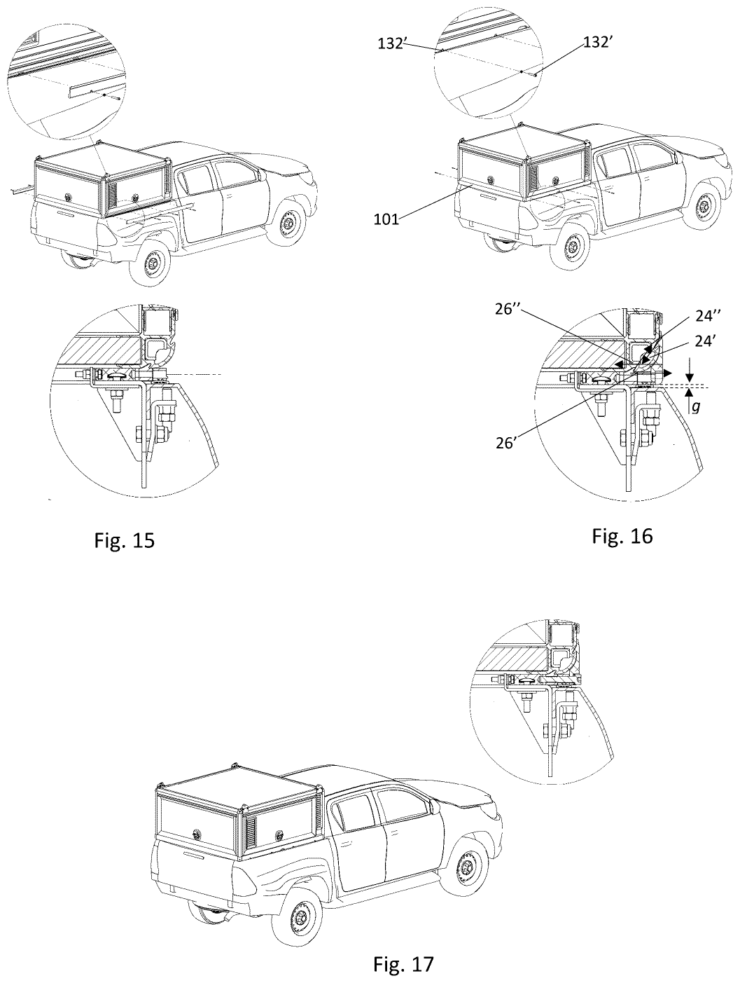

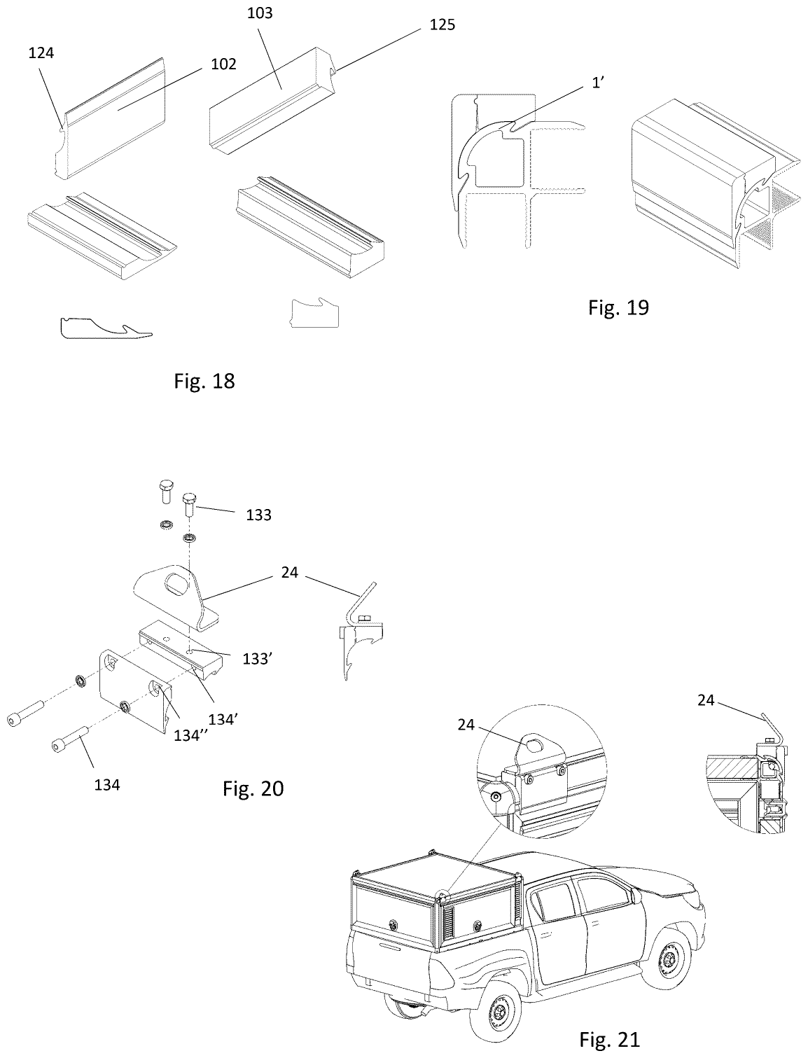

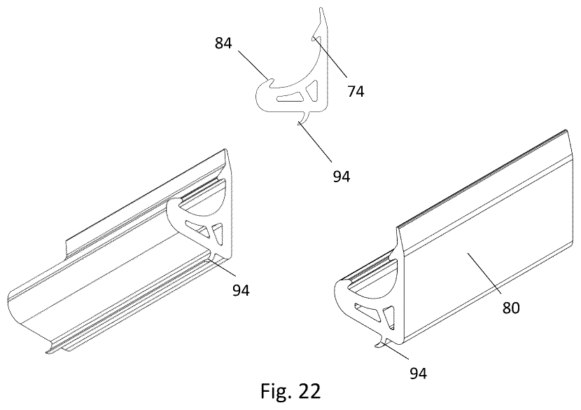

One example embodiment of the locking member assembly 3′ is outlined in FIG. 3, FIG. 4, and FIG. 9, wherein the locking member holding means 131, 131′, 131″, 131′″ comprises a first locking member conduit 131 through the locking member. The first locking member conduit 131 runs in a direction perpendicular to the longitudinal direction of the horizontal bottom side profile list 3,3′,35′ into which the locking member assembly is to be arranged. Further a first corresponding conduit 131′ is arranged perpendicular to the longitudinal direction in the groove 3″ in the horizontal bottom side profile list 3,3′,35′. A pin 131″, having a diameter less than the diameter of the first locking member conduit 131, is arranged in the combined conduits 131, 131′ to hold the locking member safely, but able to glide on the pin 131″, inside the groove 3″. The pin 131″ may have threads arranged on the upper (or lower) portion towards the head, in the portion that is to reside inside the outer part of the first corresponding conduit 131′ in the horizontal bottom side profile list 3,3′,35′. This outer (or inner) part of the first corresponding conduit 131′ in the horizontal bottom side profile list 3,3′,35′ may have corresponding threads to enable the pin 131″ to be screwed into the horizontal bottom side profile list 3,3′,35′, and at the same time enter through the first locking member conduit 131 and the inner part of the first corresponding conduit 131′ in the horizontal bottom side profile list 3,3′,35′. The thickness t1 of the locking member may advantageously be less than the thickness t2 of the groove 3″. When t1<t2 it may be room for an elastic washer member 131′″, such as a helical coil spring washer, to be arranged on the pin 131″ at the pin 131″ head side of the locking member inside the groove 3″, and the outer diameter of the elastic washer member 131′″ is larger than the first corresponding conduit 131′, it will have the effect that the locking member is held resiliently (biased) towards the inner side of the groove 31″.

A further locking member receiving element 132, conduit, is arranged in the locking member. The further locking member conduit 132 runs in a direction perpendicular to the longitudinal direction of the horizontal bottom side profile list 3,3′,35′ into which the locking member assembly is to be arranged. A further corresponding conduit 132′ is arranged perpendicular to the longitudinal direction in the horizontal bottom side profile list 3,3′,35′. A connecting bolt/further pin 132″, having a diameter equal to the diameter of the further locking member conduit 132, is arranged in the combined conduits 132, 132′ to move the locking inside the groove 32″. This may be achieved by providing corresponding threads on the outer portion of the connecting bolt 132″ and inside the further receiving element 132 in the locking member. The further corresponding conduit 132′ diameter is advantageously larger than the diameter of the connecting bolt 132″. When the connecting bolt 132″ enters into the further corresponding conduit 132′ and into the locking member and is screwed it will have the effect of the locking element is moved relative the outer side of the groove 32″.

When the object 20 is arrange onto the horizontal bottom side profile list 3,3′,35′, and the vertical bottom side profile list 2 receiving the connecting bolt 132″ entering into the corresponding conduits 132, 132′, 132′″ for fastening the vertical bottom side profile list 2, 35″ to the horizontal bottom side profile list 3,3′,35′ the object 20 is locked in the grip of the outward facing connecting elements 34 working in combination with the second corresponding connecting element 24 that interacts in a locking operation on the first connecting elements 71 and the second connecting element 72.

The outer portion of the corresponding conduit 132′″ inside the vertical bottom side profile list 2, 35″ may be formed in two sections, a first outer section adapted to receive the connecting bolt 132″ head, and an inner section adapted to receive the connecting bolt 132″ stem.

Thus, an even further secure locking is ensured when the connecting bolt 132″ is screwed into the locking member and pulling this towards the casing profile list 1 a distance dw, and thus the lock member connecting element 34′ is entering further dw into the corresponding first connecting elements 71 of the casing profile list 1. In FIG. 16 it is shown the resulting forces now working to hold the fastening assembly, pushing the vertical bottom side profile list 2, 35″ inward 26″ and at the same time the second corresponding connecting element 24 interacts with the second connecting element 72 of the casing profile list in an oblique downward movement 24′. This is happening at the same time that the lock member connecting element 34′ is pulled outwards 26′ and oblique upwards 24″ movement toward the corresponding first connecting elements 71 of the casing profile list 1. These moving forces ensure that the casing profile list 1 is securely held in a pinching grip sufficient to hold the object in accordance to loading regulations.

When removing the attached object 20 this is made easy by elastic washer member 131′″ pushing the connecting element 34′ inwards in the groove 32″ when the connecting bolt/further pin 132″ is removed (unscrewed), and the vertical bottom side profile list 2, 35″ is detached. Thus there is no elements being arranged in a locking manner with the first connecting elements 71 of the casing profile list 1. And, the object 20 may unrestricted be removed.

The horizontal bottom side profile list 3,3′,35′ further comprises on its underside a gasket groove 36 for accommodating a gasket 11, such as a rubber gasket illustrated in FIG. 11. The gasket will when the horizontal bottom side profile list 3,3′,35′ is arranged on the carrier 30 tighten the gap g between the bodywork of the carrier 30 and the underside of the horizontal bottom side profile list 3,3′,35′ as illustrated in FIG. 2.

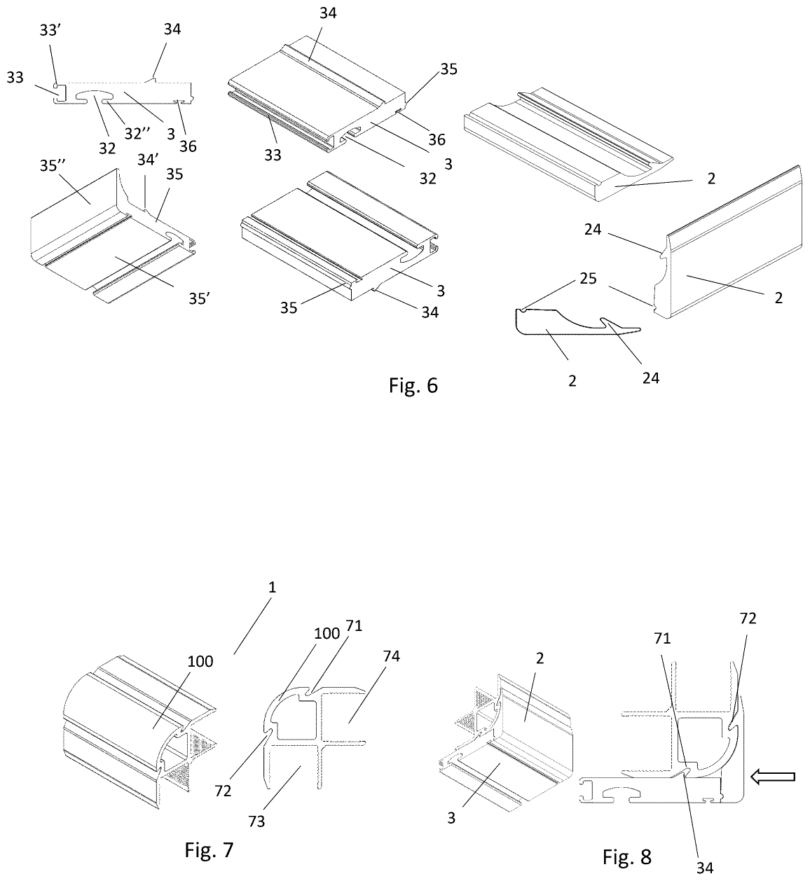

The first fastening means as discussed above and illustrated in FIG. 6 and FIG. 10 may further comprise: a vertical downward pulling fastening element 32, 32′ for holding the horizontal bottom side profile list 3 in the vertical direction to the carrier 30, and a horizontal working fastening element 33, 33′ for aligning and holding the horizontal bottom side profile list 3 in the horizontal direction relative the carrier 30.

The vertical downward pulling fastening element 32, 32′ is comprised of: a vertical holding element 32′ being arranged in a second fastening means 50, and a first receiving groove 32 being arranged longitudinally in the underside of the horizontal bottom side profile list 3, the first receiving groove 32 having a form 32″ to receive and hold the vertical holding element 32′.

The horizontal working fastening element 33, 33′ is comprised of: a horizontal holding element 33′ being arranged in a second fastening means 50, and a second receiving groove 33 being arranged longitudinally in a first side of the horizontal bottom side profile list 3, the second receiving groove 33 having a form 33″ to receive and hold the horizontal holding element 33′.

It is also provided a corner connecting element 57 for being mounted to secure perpendicular laying horizontal bottom side profile lists 3,3′,35′ to each other. Downward pulling elements 32″ is arranged to cooperate with the first receiving groove 32 of the horizontal bottom side profile list 3,3′,35′ close to the corner, and horizontal holding element 33″ is arranged to cooperate with the second receiving groove 33 of the horizontal bottom side profile list 3,3′,35′ close to the corner.

The downward pulling elements 32′, 32″ and horizontal holding element 33′, 33″ may be bolt and nut having a bolt head fitting into the corresponding first and second receiving groove 32, 33.

The horizontal bottom side profile list 3,3′,35′ may further comprise a first weight transfer/alignment element 35, and the vertical bottom side profile list 2, 35″ further comprising a second weight transfer/alignment element 25, wherein the first weight transfer/alignment element 35 and the second weight transfer/alignment element 25 cooperates to transfer and hold the weight/alignment of the object 20 attached to the carrier 30.

The second fastening means 50 may further comprise: the vertical holding element 32′, the horizontal holding element 33′, and a carrier fastening element 51, 52, 53, 53′, 53″ for fastening the second fastening means 50 to the carrier as illustrated in FIG. 10 and FIG. 14.

If the carrier 30 is a pick-up truck/lorry bed having the carrier fastening elements 51, 52, 53, 53′, 53″ for fastening the second fastening means 50 to the carrier arranged on any of the top side of side and front bed panel 55, 55′, the topside of the panel 55, 55′ may have an inward facing collar to provide an upside down oriented fold 55′, and the carrier fastening elements 51, 52, 53, 53′, 53″ comprises:
a lower vertical portion of an inner element 53 for being arranged on the inside of the upside down oriented fold 55′,
a lower vertical portion of an outer element 53′ being arranged on the outside of the upside down oriented fold 55′, and
a fastening device 52 arranged to pinch and hold the upside down oriented fold 55′ between the lower vertical portion of an inner element 53 and the lower vertical portion of an outer element 53′,
the inner element 53 further comprising:
an upper horizontal portion for holding the vertical holding element 32′, and
an upper extension portion 53″ for holding the horizontal holding element 33′, and the outer element 53′ further comprising:
an upper horizontal portion for holding an adjustable stabilizing bolt 51.

When mounted, the carrier fastening elements 51, 52, 53, 53′, 53″ is thus able to provide a secure non-intrusive arrangement and fastening brackets for the horizontal bottom side profile list 3,3′,35′. The adjustable stabilizing bolt 51 provides a height adjustment feature of the horizontal bottom side profile list 3,3′,35′, such that the object 20 may be arranged less than the gasket 11 height above the bodywork of the side panels 31 of the carrier.

The second fastening means 50 further comprise a third fastening means for further securing the second fastening means 50 to the carrier 30 such that a strap fastening element 56 providing fastening of a securing connector/strap to the carrier 30.

In the embodiment shown in the figures the carrier 30 is a pick-up truck/lorry bed having a horizontal bottom side profile list 3,3′,35′ arranged on the top side of side and front bed panel, and the object 20 is a container having mounted. On the underside of the container 20 two longitudinal parallel running casing profile list 1 is arranged for cooperating with the horizontal bottom side profile list 3, 3′ arranged on the top of the side panel 31 of the pick-up truck/lorry, and on the forward facing underside of the container 20 a further profile list 1 for being cooperating with the horizontal bottom side profile list 35′ that is arranged on the front panel. The second fastening means 50 are arranged on the top side of side bed panel 55, 55′ of the pick-up truck/lorry bed.

In a further embodiment of present disclosure the first connecting element 71, and the first corresponding connecting element 34, 34′ of the horizontal bottom side profile list 3,3′,35′ is composed of a protrusion interacting with a groove.

In a further embodiment of present disclosure the second connecting element 72, and the second corresponding connecting element 24 of the vertical bottom side profile list 2, 35″ is composed of a protrusion interacting with a groove.

In the figures the first and second connecting element 71, 72 provides the grooves of the interaction with the first and second corresponding connecting element 24, 34, 34′ providing the protrusions. It is within the scope of the present disclosure to switch around on this configuration such that any of the interactions may have opposite groove-protrusion configuration.

In an even further embodiment of present disclosure it is provided a roof casing profile list 1′ for being attached to an object 20 to be detachably fastened, the roof casing profile list 1′ may be arranged at a different side of the object 20 which is facing the casing profile locking assembly arranged on the carrier 30. A further horizontal top side profile list 103, and a vertical top side profile list 102 is provided for being arranged to interact with the horizontal top side profile list 103 for gripping the roof casing profile list 1 in a locking grip.

It is further provided a fourth fastening means 24 for securing a further object 20′ to the roof casing profile list 1′.

It is further provided a blind casing profile list 101 for being attached to an object 20 to be detachably fastened, the blind casing profile list 101 is arranged at the lower end of the rear side of the object 20 facing the upper end of a tailgate, and a tail gasket 80 having an inner form 74, 84 mirroring and adapted to being arranged to interact with the first and second connecting elements 71, 72 of the blind casing profile list 101 in a locking manner, and the tail gasket 80 further the fastening comprises a downward pointing flange portion 94 being arranged to close a gap between the tail gasket and the top of the tailgate.

The second aspect of this disclosure shows a method for fastening an object to a carrier such as a pick-up/truck bed, wherein the method comprising the steps:
arranging one or more casing profile list 1 according to the present disclosure to an object 20 to be arranged on a carrier 30,
mounting two or more carrier fastening element 51, 52, 53, 53′, 53″ to the carrier 30,
mounting one or more horizontal bottom side profile lists 3,3′,35′ to the two or more carrier fastening element 51, 52, 53, 53′, 53″,
mounting the casing profile list 1 arranged on the object 20 into the corresponding horizontal bottom side profile lists 3,3′,35′,
mounting one or more vertical bottom side profile list 2, 35″ to the horizontal bottom side profile lists 3,3′,35′, and
thereby fastening the object 29 in a tight grip.

The method may comprise the further steps:
arranging a blind casing profile list 1 at the lower end of the rear side of the object 20 facing the upper end of a tailgate of the carrier 30.

The method may comprise the further steps:
fastening one or more roof casing profile list 1′ to the upper portion of an object 20 at the opposite side of the object 20 facing the casing profile locking assembly arranged on the carrier 30, and
arranging a fourth fastening means 24 for securing a further object 20′ to the roof casing profile list 1′.

The person skilled in the art realizes that the present disclosure is not limited to the preferred embodiments described above. The person skilled in the art further realizes that modifications and variations are possible within the scope of the appended claims. Additionally, variations to the disclosed embodiments can be understood and effected by the skilled person in practicing the claimed disclosure, from a study of the drawings, the disclosure, and the appended claims.

1. A fastening assembly for use in a carrier such as a pick-up/truck bed comprising:
one or more casing profile lists attached to an object to be detachably fastened, the one or more casing profile lists arranged at a side of the object facing a casing profile locking assembly arranged on the carrier, and
the casing profile locking assembly comprising:
a horizontal bottom side profile list; and
one or more of a first fastener for holding the horizontal bottom side profile list, wherein
the horizontal bottom side profile list is fastened to the carrier, and being arranged to receive the one or more casing profile lists, and
a vertical bottom side profile list is arranged to interact with the horizontal bottom side profile list for fastening the one or more casing profile lists in a locking grip.

2. The fastening assembly according to claim 1, wherein
the one or more casing profile lists comprise a first connecting element, and
the horizontal bottom side profile list comprises a first corresponding connecting element for interacting in a guiding operation with the first connecting element.

3. The fastening assembly according to claim 1, wherein
the one or more casing profile lists comprise a second connecting element, and
the vertical bottom side profile list comprises a second corresponding connecting element for interacting in a locking grip with the second connecting element.

4. The fastening assembly according to claim 1, wherein
the horizontal bottom side profile list and the vertical bottom side profile list are provided in a combined bottom side profile list.

5. The fastening assembly according to claim 2, further comprising:
two or more locking member assemblies comprising a lock member connecting element corresponding to the first corresponding connecting element of the horizontal bottom side profile list,
the horizontal bottom side profile list comprising two or more grooves for receiving the two or more locking member assemblies,
a locking member assembly of the two or more locking member assemblies comprising:
at least one locking member holder for holding the locking member assembly in a horizontal bottom side profile list groove of the two or more grooves; and
at least one locking member receiving element, and
the horizontal bottom side profile list, the at least one locking member receiving element, and the vertical bottom side profile list comprising corresponding conduits for receiving a connecting bolt for fastening the vertical bottom side profile list to the horizontal bottom side profile list.

6. The fastening assembly according to claim 1, wherein the first fastener comprising:
a vertical downward pulling fastening element for holding the horizontal bottom side profile list in a vertical direction to the carrier; and
a horizontal working fastening element for aligning and holding the horizontal bottom side profile list in a horizontal direction relative the carrier.

7. The fastening assembly according to claim 6, wherein the vertical downward pulling fastening element comprises:
a vertical holding element arranged in a second fastener; and
a first receiving groove arranged longitudinally in an underside of the horizontal bottom side profile list, the first receiving groove having a form to receive and hold the vertical holding element.

8. The fastening assembly according to claim 6, wherein the horizontal working fastening element comprises:
a horizontal holding element arranged in a second fastener; and
a second receiving groove arranged longitudinally in a first side of the horizontal bottom side profile list, the second receiving groove having a form to receive and hold the horizontal holding element.

9. The fastening assembly according to claim 1, wherein
the horizontal bottom side profile list further comprises a first weight transfer/alignment element,
the vertical bottom side profile list further comprises a second weight transfer/alignment element, and
the first weight transfer/alignment element and the second weight transfer/alignment element cooperates to transfer and hold the weight of, and/or align, the object attached to the carrier.

10. The fastening assembly according to claim 7, wherein the second fastener comprises:
the vertical holding element;
a horizontal holding element arranged in the second fastener; and
a carrier fastening element for fastening the second fastener to the carrier.

11. The fastening assembly according to claim 10, wherein
the carrier is a pick-up truck/lorry bed having carrier fastening elements for fastening the second fastener to the carrier arranged on any of a top side of side and front bed panel, a topside of the side and front bed panel having an inward facing collar to provide an upside down oriented fold,
the carrier fastening elements comprises:
a lower vertical portion of an inner element arranged on an inside of the upside down oriented fold;
a lower vertical portion of an outer element or arranged on an outside of the upside down oriented fold; and
a fastening device arranged to pinch and hold the upside down oriented fold between the lower vertical portion of the inner element and the lower vertical portion of the outer element,
the inner element further comprises:
an upper horizontal portion for holding the vertical holding element; and
an upper extension portion for holding the horizontal holding element, and
the outer element further comprises:
an upper horizontal portion for holding a stabilizing bolt.

12. The fastening assembly according to claim 7, wherein the second fastener further comprises:
a third fastener for further securing the second fastener to the carrier.

13. The fastening assembly according to claim 12, wherein the third fastener comprises a strap fastening element configured to fasten a securing connector/strap to the carrier.

14. The fastening assembly according to claim 1, wherein
the carrier is a pick-up truck/lorry bed having the horizontal bottom side profile list arranged on a top side of side and front bed panel, and the object is a container having mounted:
on an underside of the object, two longitudinal parallel running casing profile lists for cooperating with the horizontal bottom side profile list arranged on a side panel, and
on a forward facing underside of the object, a further profile list for cooperating with the horizontal bottom side profile list arranged on a front panel, and
a second fastener is arranged on a top side of a side bed panel of the side and front bed panel of the pick-up truck/lorry bed.

15. The fastening assembly according to claim 2, wherein the first connecting element and the first corresponding connecting element of the horizontal bottom side profile list comprise a protrusion interacting with a groove.

16. The fastening assembly according to claim 3, wherein the second connecting element, and the second corresponding connecting element of the vertical bottom side profile list comprise a protrusion interacting with a groove.

17. The fastening assembly according to claim 1, further comprising:
one or more roof casing profile lists attached to the object to be detachably fastened, the one or more roof casing profile lists arranged at a different side of the object facing the casing profile locking assembly arranged on the carrier;
a horizontal top side profile list; and
a vertical top side profile list arranged to interact with the horizontal top side profile list for gripping the one or more roof casing profile lists in a locking grip.

18. The fastening assembly according to claim 17, further comprising:
a fourth fastener for securing a further object to the one or more roof casing profile lists.

19. The fastening assembly according to claim 1, further comprising:
a blind casing profile list attached to an object to be detachably fastened, the blind casing profile list is arranged at a lower end of a rear side of the object facing an upper end of a tailgate; and
a tail gasket having an inner form mirroring and adapted to be arranged to interact with first and second connecting elements of the blind casing profile list in a locking manner, and the tail gasket further comprising a downward pointing flange portion arranged to close a gap between the tail gasket and a top of the tailgate.

20. A method for fastening an object to a carrier such as a pick-up/truck bed, the method comprising:
arranging the one or more casing profile lists according to claim 1 to the object to be arranged on a carrier;
mounting two or more carrier fastening elements to the carrier;
mounting one or more horizontal bottom side profile lists to the two or more carrier fastening elements;
mounting the one or more casing profile lists arranged on the object into corresponding one or more horizontal bottom side profile lists; and
mounting one or more vertical bottom side profile list to the one or more horizontal bottom side profile lists, thereby fastening the object in a tight grip.

21. The method according to claim 20, further comprising:
arranging a blind casing profile list at a lower end of a rear side of the object facing an upper end of a tailgate of the carrier.

22. The method according to claim 20, further comprising:
fastening one or more roof casing profile lists to an upper portion of the object at an opposite side of the object facing the casing profile locking assembly arranged on the carrier; and
arranging a fourth fastener for securing a further object to the one or more roof casing profile lists.
